(19) United States
(12) Patent Application Publication
(10) Pub. No.: US 2025/0115775 A1
(43) Pub. Date: Apr. 10, 2025

(54) ENVIRONMENTALLY FRIENDLY WATER-BASED PRINTING INK MANUFACTURING METHOD

(71) Applicants: Trust Active Co., Ltd, New Taipei City (TW); Color Active Co., Ltd., New Taipei (TW)

(72) Inventors: Chih-Yu LEE, New Taipei (TW); Sy-Yi TZENG, New Taipei (TW); Jen-Yuan KAO, New Taipei (TW)

(21) Appl. No.: 18/484,068

(22) Filed: Oct. 10, 2023

(51) Int. Cl. C09D 11/107

(52) U.S. Cl. CPC C09D 11/107

(57) ABSTRACT

An environmentally friendly water-based printing ink manufacturing method includes the steps of: placing a color paste into a barrel for stirring at a high speed, placing an anti-scratch hardener and a slow-drying agent in batches and continuing stirring, placing a mixture of anti-scratch hardener and slow-drying agent in a specific ratio, placing a scratch-resistant and chemical-resistant resin and a wear-resistant wetting resin, placing a defoaming agent and continuing stirring for a first predetermined time, placing a thickener and continuing stirring for a second predetermined time, placing a wetting agent and continuing stirring for a third predetermined time, placing a film-forming agent and continuing stirring for a fourth predetermined time, measuring the pH value of the printing ink and adjusting the printing ink to make the printing ink weakly alkaline, filtering the printing ink and packing the printing ink into barrels to complete the manufacturing process.

### BACKGROUND OF THE INVENTION

### 1. Field of the Invention

The present invention relates to printing ink technology and more particularly, to an environmentally friendly water-based printing ink manufacturing method that does not pollute the environment and has no impact on human health. It can improve the printing working environment, reduce the harm to employee health, and also reduce the pollution of packaging products. It is also safe and not easy to burn. At the same time, because it does not contain solvents, it will not corrode the printing plate and relatively increase the life of the plate. It is especially suitable for non-toxic printing inks for packaging printing of food, beverages, medicines, etc.

### 2. Description of the Related Art

According to the choice of printing ink in the printing process, solvent-based printing ink is currently the most used. Solvent-based printing ink uses the evaporation of the solvent to accelerate drying, and the solvent ratio after dilution can be as high as 80% or more. Solvent-based printing inks contain organic solvents such as poly aromatic hydrocarbons (PAH) and ozone depleting chemicals (ODC). The higher the solvent content, the easier it is for volatile organic compounds (VOC) to volatilize into the air during printing or drying, which is currently the largest source of pollution in the printing industry.

Volatile organic compounds (VOC): refers to the general term for air pollutants of organic compounds whose initial boiling point is measured below 250 degrees Celsius under one atmosphere. But it does not contain compounds such as methane, carbon monoxide, carbon dioxide, carbon disulfide, carbonic acid, carbonate, ammonium carbonate, cyanide or thiocyanide. (“Volatile Organic Compounds Air Pollution Control and Emission Standards”), under normal temperatures and pressures, VOCs are organic chemicals with high vapor pressure and easy evaporation. After it escapes into the atmosphere and is exposed to sunlight, it will react with nitrogen oxides to cause an increase in ozone concentration, or when combined with fine particles and other substances in dust, it will produce secondary pollutants such as photochemical smog, which will cause damage to the eyes and respiratory tract. lungs, etc. Some of these chemicals, such as benzene, toluene, and halogenated carbons and halogenated alkenes (dichloroethylene, trichlorethylene), have been suspected or confirmed to be carcinogens. They not only cause harm to animals and plants, but also bring pollution problems such as the greenhouse effect to the environment.

General printing ink types include traditional solvent-based printing inks and environmentally friendly printing inks. Environmentally friendly printing inks can be divided into water-based printing inks, vegetable oil printing inks, UV printing inks, electron beam drying printing inks, and bio-printing inks. Water-based printing ink uses water as the main raw material, replacing traditional volatile organic solvents. According to the definition of the U.S. Environmental Protection Agency (USEPA), water-based printing ink refers to printing inks containing ammonia, ethanol, glycol and other ingredients, and its diluted VOCs content should be less than 5%. The biggest feature of water-based printing ink is that it does not pollute the environment and has no impact on human health. It can improve the printing working environment, reduce the harm to employee health, and can also reduce the pollution of packaging products. It is also safe and not easy to burn. At the same time, because it does not contain solvents, it will not corrode the printing plate and relatively increase the life of the plate. It is especially suitable for packaging printing of food, beverages, medicines, etc., and is currently the only non-toxic printing ink recognized by the American Food and Drug Association.

Currently, Taiwan's demand for higher-quality printing inks mostly relies on imports. The key technologies for environmentally friendly printing inks such as water-based printing inks are in the hands of large foreign companies. As a result, the domestic printing industry has to pay higher prices to use high-quality water-based environmentally friendly printing inks. Major foreign manufacturers have fixed specifications for printing inks that cannot be changed. If the printing materials cannot be applied, there is no guarantee for the printing industry. Therefore, it is necessary to develop water-based printing inks domestically.

### SUMMARY OF THE INVENTION

In view of the above-mentioned problems and deficiencies, the inventor collected relevant information, and after various evaluations and considerations, he designed this environmentally friendly water-based printing ink manufacturing method.

It is the main object of the present invention to provide an environmentally friendly water-based printing ink manufacturing method. This environmentally friendly water-based printing ink is mainly used for printing on polypropylene terephthalate (PET), cast polypropylene (CPP) or oriented polypropylene (OPP) plastic films used in food or hygiene product packaging. The environmentally friendly water-based printing ink manufacturing method includes the steps of: placing a color paste into a barrel that is equipped with a mixer, and stirring the mixer at a predetermined high speed; putting an anti-scratch hardener and a slow-drying agent into the barrel in batches and continuing stirring, where the weight percentage of the anti-scratch hardener and the slow-drying agent is 10:1, and the slow-drying agent is composed of a mixture of potassium siliconate and water; placing a mixture of the anti-scratch hardener and the slow-drying agent in a specific ratio into the barrel; placing a scratch-resistant and chemical-resistant resin and a wear-resistant wetting resin into the barrel; placing a defoaming agent into the barrel and continuing stirring for a first predetermined time, where the defoaming agent is a modified polysiloxane containing fumed silica; placing a thickener into the barrel and continuing stirring for a second predetermined time, where the thickener is composed of a polyether-type polyurethane resin solution; placing a wetting agent into the barrel and continuing stirring for a third predetermined time, where the wetting agent is composed of tetramethyl-5-decyne-4,7-diol+1,2-propanediol; placing a film-forming agent into the barrel and continuing stirring for a fourth predetermined time, where the film-forming agent is composed of mixed solvent and a nonionic surfactant; measuring the pH value of the printing ink in the barrel and adjusting the printing ink to make the printing ink weakly alkaline; and filtering the printing ink and then packing the printing ink into barrels to complete the manufacturing process.

The secondary object of the present invention is that when the mixed viscosity of the anti-scratch hardener, the slow-drying agent and the color paste is too high, add a diluent to reduce the viscosity. The diluent is composed of a resin with a specific component. The preparation method of the diluent is to add a second component resin, amine water and water into a reaction kettle, stir until completely dissolved, and raise the temperature to 85° C. to obtain a first mixture, then, mix phenylethene, methyl methacrylate, butyl acrylate and butyl methacrylate (4:4:1:1) evenly and add the mixture of phenylethene, methyl methacrylate, butyl acrylate and butyl methacrylate (4:4:1:1) dropwise to the first mixture at 3H (hours), and at the same time, add water dissolved in ammonium persulfate APS dropwise to the first mixture at 3H (hours) to obtain a second mixture, and continue to heat the second mixture to 90° C., keep the second mixture warm for 1.5 hours, cool the second mixture to room temperature, then adjust the pH value to about 8, and then filter the material to obtain the diluent.

Another object of the present invention is that the slow-drying agent is potassium siliconate with a solid content of 100% and diluted with water to a solid content of 55%, and the anti-scratch hardener is composed of a first density-increasing resin and a second density-increasing resin.

Still another object of the present invention is that the production method of the first density-increasing resin is to add high molecular weight water-based acrylic resin (styrene-a-methylstyrene-acrylic acid copolymer [>98.5%]+dipropylene glycol monomethyl ether [<1.5%]) (molecular weight above 10,000), amine water and water into a reaction kettle, then stir until completely dissolved and heat up to 85° C. to obtain a resin solution, then, mix phenylethene, methyl methacrylate, butyl acrylate and butyl methacrylate (0.5:0.5:4.5:4.5) evenly, and add the mixture of phenylethene, methyl methacrylate, butyl acrylate and butyl methacrylate (0.5:0.5:4.5:4.5) dropwise to the resin solution at 3H (hours), and at the same time, add water dissolved in ammonium persulfate APS dropwise to the resin solution at 3H (hours) to obtain a first dense resin, and then, raise the temperature of the first dense resin to 90° C., keep the first dense resin warm for 1.5 hours, cool the first dense resin to room temperature, adjust the pH value to about 8, and then filter out the material.

Still another object of the present invention is that the production method of the second density-increasing resin is to add water-based acrylic solid resin (modified styrene acrylic polymer [>98.5%]+acrylic acid [0.2˜0.3%]) (molecular weight above 16,000), amine water and water to a reaction kettle, stir until completely dissolved, and raise the temperature to 85° C. to obtain a resin solution, then, mix phenylethene, methyl methacrylate, butyl acrylate and butyl methacrylate (2:2:3:3) evenly, add dropwise to the resin solution at 3H (hours), and at the same time add dissolved ammonium persulfate APS of water dropwise to the resin solution at 3H (hours) to obtain a second dense resin, then, raise the temperature of the second dense resin to 90° C., keep the second dense resin warm for 1.5 hours, cool the second dense resin to room temperature, adjust the pH value to about 8, and then filter out the material.

### BRIEF DESCRIPTION OF THE DRAWINGS

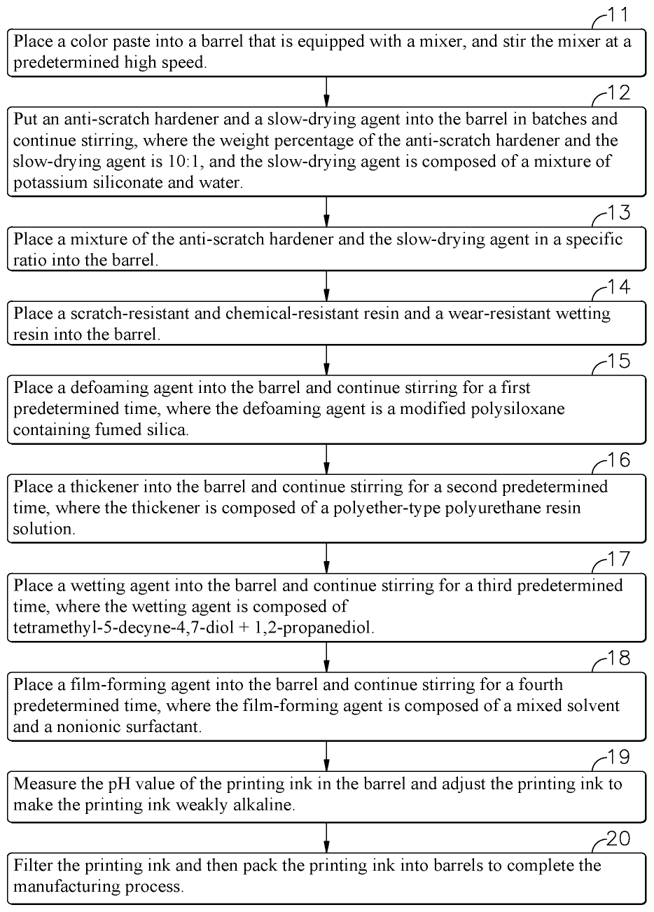

The FIG. 1 is a flow chart of the environmentally friendly water-based printing ink manufacturing method of the present invention.

### DETAILED DESCRIPTION OF THE PREFERRED EMBODIMENT

In order to achieve the above objects and effect, the technical means and structure adopted in this invention, the drawing is hereby described in detail with respect to the preferred embodiment of this invention. Its features and functions are as follows for fully understand.

Please refer to the FIG. 1, which is a flow chart of the environmentally friendly water-based printing ink manufacturing method of the present invention. As shown in the FIGURE, it can be clearly seen that the environmentally friendly water-based printing ink prepared by the present invention is mainly used for printing on polypropylene terephthalate (PET), cast polypropylene (CPP) or oriented polypropylene (OPP) plastic films used in food or sanitary product packaging. The environmentally friendly water-based printing ink manufacturing method of the present invention comprises the following steps:

Step 11: Place a color paste into a barrel. The barrel is equipped with a mixer. The mixer stirs at a predetermined high speed. The predetermined high speed range of the mixer is 2000 rpm to 4000 rpm. The colors of the color paste include yellow, megenta, black, white and gray. Due to the different colors that various color printing inks can present and the needs of different attachments, there are slight adjustments in formula dosage and weight percentage for the color paste, anti-scratch hardener, slow-drying agent, diluent, defoaming agent, film-forming agent, thickener and pure water required between various color printing inks in the manufacturing process. However, the weight percentage data of the dosage of this formula have nothing to do with the characteristic technical content of the present invention and will not be disclosed here.

Step 12: Put an anti-scratch hardener and a slow-drying agent into the barrel in batches and continue stirring. The weight percentage of the anti-scratch hardener and the slow-drying agent is 10:1. The slow-drying agent is composed of a mixture of potassium siliconate and water. The slow-drying agent is potassium siliconate with a solid content of 100% and diluted with water to a solid content of 55%.

The above-mentioned anti-scratch hardener is composed of a first density-increasing resin and a second density-increasing resin. The production method of the first density-increasing resin is to add high molecular weight water-based acrylic resin (Styrene-a-Methylstyrene-Acrylic Acid Copolymer [>98.5%]+Dipropylene Glycol Monomethyl Ether [<1.5%]) (molecular weight above 10,000), amine water and water into the reaction kettle, then stir until completely dissolved and heat up to 85° C. to obtain a resin solution. Then, mix phenylethene, methyl methacrylate, butyl acrylate, and butyl methacrylate (0.5:0.5:4.5:4.5) evenly, and add dropwise to the resin solution at 3H (hours). At the same time, water dissolved in ammonium persulfate APS is added dropwise to the resin solution at 3H (hours) to obtain the first dense resin. Then, raise the temperature of the first dense resin to 90° C., keep it warm for 1.5 hours, cool it to room temperature, adjust the pH value to about 8, and filter out the material.

Following the above, the production method of the second density-increasing resin is to add water-based acrylic solid resin (Modified Styrene Acrylic Polymer [>98.5%]+Acrylic acid [0.2˜0.3%]) (molecular weight above 16,000), amine water and water to the reaction kettle, stir until completely dissolved, and raise the temperature to 85° C. to obtain resin solution. Then, mix phenylethene, methyl methacrylate, butyl acrylate, and butyl methacrylate (2:2:3:3) evenly, add dropwise to the resin solution at 3H (hours), and at the same time add dissolved ammonium persulfate APS of water dropwise to the resin solution at 3H to obtain a second dense resin. Then, raise the temperature of the second dense resin to 90° C., keep it warm for 1.5 hours, cool it to room temperature, adjust the pH value to about 8, and then filter out the material.

When the mixed viscosity of the anti-scratch hardener, the slow-drying agent and the color paste is too high, a diluent is added to reduce the viscosity. The diluent is composed of a resin with a specific component and can effectively dilute the anti-scratch hardener component. The preparation method of the diluent is to add a second component resin, amine water and water into a reaction kettle, stir until completely dissolved, and raise the temperature to 85° C. to obtain a first mixture. Then, mix phenylethene, methyl methacrylate, butyl acrylate, and butyl methacrylate (4:4:1:1) evenly, and add dropwise to the first mixture at 3H (hours). At the same time, water dissolved in ammonium persulfate APS is added dropwise to the first mixture at 3H (hours) to obtain a second mixture. Continue to heat the second mixture to 90° C., keep it warm for 1.5 hours, cool it to room temperature, adjust the pH value to about 8, and filter the material to obtain the diluent.

Step 13: Place a mixture of the anti-scratch hardener and the slow-drying agent in a specific ratio into the barrel.

Step 14: Place a scratch-resistant and chemical-resistant resin and a wear-resistant wetting resin into the barrel.

The scratch-resistant and chemical-resistant resin mentioned above is made by adding high molecular weight acrylic resin (Modified Styrene Acrylic Polymers) (molecular weight above 15,000), amine water and water to the reaction kettle, stirring until completely dissolved, and raising the temperature to 85° C. to obtain a resin solution. Then, mix phenylethene (whose chemical formula is C₅H₈), methyl methacrylate (whose chemical formula is C₅H₈O₂), butyl acrylate (whose chemical formula is C₇H₁₂O₂), butyl methacrylate (whose chemical formula is C₈H₁₄O₂) (4:4:1:1) evenly, and add dropwise to the resin solution at 3H (hours), and at the same time, water dissolved in ammonium persulfate APS is added dropwise to the resin solution at 3H (hours) to obtain the scratch-resistant and chemical-resistant resin. Then, heat the scratch-resistant and chemical-resistant resin to 90° C., keep it warm for 1.5 hours, cool it to room temperature, adjust the pH value to about 8, and filter out the material.

The production method of the above-mentioned wear-resistant wetting resin is to add 20 kg of oxidized polyethylene wax, 10 kg of polyethylene wax, and 6 kg of nonionic surfactant of primary alcobol ethoxylate into a high-pressure emulsification kettle, heat the mixture to 110-140° C. to melt all materials, and slowly add 90° C. hot water 64 kg and stir at high speed at the same time, keep warm for 1 hour and then cool quickly, stir evenly and then discharge to get the product.

Step 15: Place a defoaming agent into the barrel and continue stirring for a first predetermined time, and the defoaming agent is a modified polysiloxane containing fumed silica (SiO₂). The first predetermined time range is 20 to 40 minutes. The defoaming agent composed of modified polysiloxane containing fumed silica has a solid content of 24%.

Step 16: Place a thickener into the barrel and continue stirring for a second predetermined time. The thickener is composed of a polyether-type polyurethane resin solution, and use Zahn Cup #4 to measure whether the seconds are within the standard range. If the viscosity is too low, add an appropriate amount of thickener (the thickener required varies according to the color paste), stir for a second predetermined time, measure the viscosity, and repeat the above steps until the standard is met. The second predetermined time range is 50 to 70 minutes. After the viscosity is adjusted, the mixer is stirred for a period of time at a predetermined low speed, and the predetermined low speed range is 500 rpm to 1500 rpm. Stop stirring and eliminate the foam on the surface of the printing ink, then proceed to Step 20.

The thickener of the above-mentioned polyether-type polyurethane resin solution is a mixture composed of 3-12% ethylene glycol butyl ether (C₆H₁₄O₂), 2-8% ethylene glycol monophenyl ether (C₈HO₂), 23-27% polyester urethane resin and 50-75% water (H₂O) by weight.

Step 17: Place a wetting agent into the barrel and continue stirring for a third predetermined time. The third predetermined time range is 50 to 70 minutes, and the wetting agent is composed of tetramethyl-5-decyne-4,7-diol+1,2-propanediol.

Step 18: Place a film-forming agent into the barrel and continue stirring for a fourth predetermined time. The film-forming agent is composed of a mixed solvent and a nonionic surfactant. The fourth predetermined time range is 20 to 40 minutes. After adding the film-forming agent and stirring continuously for the fourth predetermined time, use a viscosity cup to measure the viscosity of the printing ink in the barrel. If the viscosity is too low, continue to add thickener to reach the predetermined viscosity. After the viscosity is adjusted, stir the mixer at a predetermined high speed for a period of time. On the other hand, if the viscosity is too high, add an appropriate amount of pure water to dilute it to reach the predetermined viscosity. After the viscosity is adjusted, the mixer is stirred for a period of time at a predetermined low speed, and the predetermined low speed range is 500 rpm to 1500 rpm. After stopping stirring, eliminate the foam generated on the surface of the printing ink and then measure the viscosity again. When the viscosity meets the preset standard, proceed to Step 19.

The above-mentioned first embodiment of the film-forming agent is composed of an environmentally friendly mixed solvent and the nonionic surfactant. This environmentally friendly mixed solvent is composed of ethoxylated-C12-18-alcohol (Fatty Alcohol Polyglycol Ether), whose chemical formula is C₁₂H₂₅O(CH₂CH₂O)₉H. The nonionic surfactant is composed of 1-methoxy-2-propanol, whose chemical formula is C₄H₁₀O₂.

The second embodiment of the film-forming agent is composed of a high boiling point mixed solvent and the nonionic surfactant. This high boiling point mixed solvent is composed of COCETH-3. The nonionic surfactant is composed of dipropylene glycol monomethyl ether, whose chemical formula is C₇H₁₆O₃.

Step 19: Measure the pH value of the printing ink in the barrel and adjust the printing ink to make it weakly alkaline. The method of adjusting the printing ink to make it weakly alkaline is to add amine water or a pH adjuster, and the pH range of the printing ink is between 8 and 10.

Step 20: Filter the printing ink and then pack the printing ink into barrels to complete the manufacturing process. After filtering the printing ink and before loading it into barrels, take out 300 to 500 grams (G) of the printing ink as product samples to record the production weight and consumption, and as a data reference for production review and improvement.

Through the disclosure of the manufacturing process of the environmentally friendly water-based printing ink of the above invention, it can be understood that the main purpose of the invention is to manufacture a water-based printing ink that does not pollute the environment and has no impact on human health. It can improve the printing operation environment and reduce the harm to the health of employees. it can also reduce pollution to packaged products, and at the same time has the characteristics of safety and non-flammability. At the same time, because it does not contain solvents, it will not corrode the printing plate and relatively increase the life of the plate. It is especially suitable for non-toxic printing inks for packaging printing of food, beverages, medicines, etc.

The above description is only preferred embodiments of the present invention, and does not limit the patent scope of the present invention. Therefore, all simple modifications and equivalent structural changes made by using the content of the specification and drawing of the present invention should be included in the patent scope of the present invention.

What the invention claimed is:

1. An environmentally friendly water-based printing ink manufacturing method for manufacturing an environmentally friendly water-based printing ink mainly used for printing on polypropylene terephthalate, cast polypropylene or oriented polypropylene plastic films used in food or hygiene product packaging, said environmentally friendly water-based printing ink manufacturing method comprising steps of:
(A) placing a color paste into a barrel that is equipped with a mixer, and stirring said mixer at a predetermined high speed ranging from 2000 rpm to 4000 rpm;
(B) putting an anti-scratch hardener and a slow-drying agent into said barrel in batches and continuing stirring, where a weight percentage of said anti-scratch hardener and said slow-drying agent is 10:1, and said slow-drying agent is composed of a mixture of potassium siliconate and water;
(C) placing a mixture of said anti-scratch hardener and said slow-drying agent in a specific ratio into said barrel;
(D) placing a scratch-resistant and chemical-resistant resin and a wear-resistant wetting resin into said barrel;
(E) placing a defoaming agent into said barrel and continuing stirring for a first predetermined time, where said first predetermined time ranges from 20 to 40 minutes and said defoaming agent is a modified polysiloxane containing fumed silica (SiO₂);
(F) placing a thickener into said barrel and continuing stirring for a second predetermined time, where said second predetermined time ranges from 50 to 70 minutes, and said thickener is composed of a polyether-type polyurethane resin solution;
(G) placing a wetting agent into said barrel and continuing stirring for a third predetermined time, where said third predetermined time ranges from 50 to 70 minutes, and said wetting agent is composed of tetramethyl-5-decyne-4,7-diol+1,2-propanediol;
(H) placing a film-forming agent into said barrel and continuing stirring for a fourth predetermined time, where said fourth predetermined time ranges from 20 to 40 minutes, and said film-forming agent is composed of a mixed solvent and a nonionic surfactant;
(I) measuring a pH value of said printing ink in said barrel and adjusting said printing ink to make said printing ink weakly alkaline; and
(J) filtering said printing ink and then packing said printing ink into barrels to complete said manufacturing process.

2. The environmentally friendly water-based printing ink manufacturing method as claimed in claim 1, wherein in said step (B), when a mixed viscosity of said anti-scratch hardener, said slow-drying agent and said color paste is too high, add a diluent to reduce said viscosity, said diluent being composed of a resin with a specific component, a preparation method of said diluent being to add a second component resin, amine water and water into a reaction kettle, stir until completely dissolved, and raise a temperature to 85° C. to obtain a first mixture, then, mix phenylethene, methyl methacrylate, butyl acrylate and butyl methacrylate (4:4:1:1) evenly and add said mixture of said phenylethene, said methyl methacrylate, said butyl acrylate and said butyl methacrylate (4:4:1:1) dropwise to said first mixture at 3H (hours), and at the same time, add water dissolved in ammonium persulfate APS dropwise to said first mixture at 3H (hours) to obtain a second mixture, and continue to heat said second mixture to 90° C., keep said second mixture warm for 1.5 hours, cool said second mixture to room temperature, then adjust a pH value to about 8, and then filter said material to obtain said diluent.

3. The environmentally friendly water-based printing ink manufacturing method as claimed in claim 1, wherein in said step (B), said slow-drying agent is a solid content of 100% potassium siliconate diluted with water to a solid content of 55%.

4. The environmentally friendly water-based printing ink manufacturing method as claimed in claim 1, wherein in said step (B), said anti-scratch hardener is composed of a first density-increasing resin and a second density-increasing resin.

5. The environmentally friendly water-based printing ink manufacturing method as claimed in claim 4, wherein a production method of said first density-increasing resin is to add high molecular weight water-based acrylic resin (styrene-a-methylstyrene-acrylic acid copolymer [>98.5%]+dipropylene glycol monomethyl ether [<1.5%]) (molecular weight above 10,000), amine water and water into a reaction kettle, then stir until completely dissolved and heat up to 85° C. to obtain a resin solution, then, mix phenylethene, methyl methacrylate, butyl acrylate and butyl methacrylate (0.5:0.5:4.5:4.5) evenly, and add said mixture of phenylethene, methyl methacrylate, butyl acrylate and butyl methacrylate (0.5:0.5:4.5:4.5) dropwise to said resin solution at 3H (hours), and at the same time, add water dissolved in ammonium persulfate APS dropwise to said resin solution at 3H (hours) to obtain a first dense resin, and then, raise a temperature of said first dense resin to 90° C., keep said first dense resin warm for 1.5 hours, cool said first dense resin to room temperature, adjust a pH value to about 8, and then filter out said material.

6. The environmentally friendly water-based printing ink manufacturing method as claimed in claim 4, wherein in said step (B), a production method of said second density-increasing resin is to add water-based acrylic solid resin (modified styrene acrylic polymer [>98.5%]+acrylic acid [0.2˜0.3%]) (molecular weight above 16,000), amine water and water to a reaction kettle, stir until completely dissolved, and raise a temperature to 85° C. to obtain a resin solution, then, mix phenylethene, methyl methacrylate, butyl acrylate and butyl methacrylate (2:2:3:3) evenly, add dropwise to said resin solution at 3H (hours), and at the same time add dissolved ammonium persulfate APS of water dropwise to said resin solution at 3H (hours) to obtain a second dense resin, then, raise said temperature of said second dense resin to 90° C., keep said second dense resin warm for 1.5 hours, cool said second dense resin to room temperature, adjust a pH value to about 8, and then filter out said material.

7. The environmentally friendly water-based printing ink manufacturing method as claimed in claim 1, wherein in said step (D), said scratch-resistant and chemical-resistant resin is made by adding high molecular weight acrylic resin (modified styrene acrylic polymers) (molecular weight above 15,000), amine water and water to a reaction kettle, stirring until completely dissolved, and raising a temperature to 85° C. to obtain a resin solution, then, mixing phenylethene (C₈H₈), methyl methacrylate (C₅H₈O₂), butyl acrylate (C₇H₁₂O₂), butyl methacrylate (C₈H₁₄O₂) (4:4:1:1) evenly, and adding dropwise to said resin solution at 3H (hours), and at the same time, adding water dissolved in ammonium persulfate APS dropwise to said resin solution at 3H (hours) to obtain said scratch-resistant and chemical-resistant resin, and then heating said scratch-resistant and chemical-resistant resin to 90° C., keeping said scratch-resistant and chemical-resistant resin warm for 1.5 hours, cooling said scratch-resistant and chemical-resistant resin to room temperature, adjusting a pH value to about 8, and then filtering out said material.

8. The environmentally friendly water-based printing ink manufacturing method as claimed in claim 1, wherein in said step (D), said wear-resistant wetting resin is made by adding 20 kg of oxidized polyethylene wax, 10 kg of polyethylene wax, and 6 kg of nonionic surfactant of primary alcobol ethoxylate into a high-pressure emulsification kettle, then heating said mixture to 110-140° C. to melt all materials, and slowly adding 90° C. hot water 64 kg and stirring at high speed at the same time, keeping warm for 1 hour and then cooling quickly, stirring evenly and then discharging to get the product.

9. The environmentally friendly water-based printing ink manufacturing method as claimed in claim 1, wherein in said step (E), said defoaming agent composed of said modified polysiloxane containing fumed silica (SiO₂) has 24 predetermined weight units remaining after drying out of 100 predetermined weight units, resulting in a solid content of 24%.

10. The environmentally friendly water-based printing ink manufacturing method as claimed in claim 1, wherein in said step (F), after adding said thickener and continuing to stir for said second predetermined time, use a viscosity cup to measure a viscosity of said printing ink in said barrel, and if said viscosity is too low, continue to add said thickener to reach a predetermined viscosity, and stir said mixer at a predetermined low speed for a period of time ranging from 500 rpm to 1500 rpm after said viscosity is adjusted, than stop stirring and eliminate a foam on a surface of said printing ink, then proceed to step (G).

11. The environmentally friendly water-based printing ink manufacturing method as claimed in claim 1, wherein in said step (F), said thickener composed of said polyether-type polyurethane resin solution is a mixture composed of 3-12% ethylene glycol butyl ether (C₆H₁₄O₂), 2-8% ethylene glycol monophenyl ether (C₈HO₂), 23-27% polyester urethane resin and 50-75% water (H₂O) by weight.

12. The environmentally friendly water-based printing ink manufacturing method as claimed in claim 1, wherein in said step (H), after adding said film-forming agent and continuing to stir for said fourth predetermined time, use a viscosity cup to measure a viscosity of said printing ink in said barrel; if said viscosity is too low, continue to add said thickener to reach a predetermined viscosity, then stir said mixer at a predetermined high speed ranging from 2000 rpm to 4000 rpm for a period of time after said viscosity is adjusted; if said viscosity is too high, add an appropriate amount of pure water to dilute to reach a predetermined viscosity, then stir said mixer at a predetermined low speed ranging from 500 rpm to 1500 rpm for a period of time; after stopping stirring, eliminate a foam generated on a surface of said printing ink and then measure said viscosity again, and then a proceed to step (I) after said viscosity meets a preset standard.

13. The environmentally friendly water-based printing ink manufacturing method as claimed in claim 1, wherein in said step (H), said film-forming agent is composed of an environmentally friendly mixed solvent and said nonionic surfactant, said environmentally friendly mixed solvent is composed of ethoxylated-C12-18-alcohol (fatty alcohol polyglycol ether), said nonionic surfactant is composed of 1-methoxy-2-propanol.

14. The environmentally friendly water-based printing ink manufacturing method as claimed in claim 1, wherein in said step (H), said film-forming agent is composed of a high boiling point mixed solvent and said nonionic surfactant, said high boiling point mixed solvent is composed of COCETH-3, and said nonionic surfactant is composed of dipropylene glycol monomethyl ether.

15. The environmentally friendly water-based printing ink manufacturing method as claimed in claim 1, wherein in said step (I), the method of adjusting said printing ink to make said printing ink weakly alkaline is to add amine water, and said pH range of said printing ink is between 8 and 10.

16. The environmentally friendly water-based printing ink manufacturing method as claimed in claim 1, wherein in said step (J), after said printing ink is filtered and before said printing ink is packed into said barrels, 300 to 500 grams of said printing ink is taken out as a product sample to record a production weight and consumption.
